(19) United States
(12) Patent Application Publication
(10) Pub. No.: US 2026/0209107 A1
(43) Pub. Date: Jul. 23, 2026

(54) LITHIUM-FREE HIGH MODULUS FIBERGLASS COMPOSITION

(71) Applicant: Owens Corning Intellectual Capital, LLC, Toledo, OH (US)

(72) Inventor: Michelle L. Korwin-Edson, Granville, OH (US)

(21) Appl. No.: 19/142,791

(22) PCT Filed: Jan. 5, 2024
(86) PCT No.: PCT/US2024/010427

§ 371 Date: Jun. 24, 2025

Related U.S. Application Data
(60) Provisional application No. 63/478,712, filed on Jan. 6, 2023.

(51) Int. Cl. C03C 3/087; C03C 13/04

(52) U.S. Cl. CPC C03C 3/087; C03C 13/046

(57) ABSTRACT

A lithium-free glass composition is disclosed that includes SiO₂ in an amount from 50 to 58% by weight; Al₂O₃ in an amount from 18 to 22% by weight; CaO in an amount from 7 to 12% by weight; MgO in an amount from 11.5 to 15% by weight; Na₂O in an amount from 0.05 to 0.5% by weight; ZrO₂ in an amount from 0 to 5 wt. %; and Li₂O in an amount less than 0.5% by weight, and the combined amount of SiO₂+Al₂O₃+MgO+CaO is less than or equal to 99.5% by weight; expressed as percentages by weight based on the weight of the entire composition. The composition satisfies at least one of the following: a ratio C1 (C1=SiO₂/(MgO+CaO)) of 2.3-2.7; a ratio C2 (C2=MgO/CaO) of at least 1.3, and a ratio C4 (C4=Al³⁺/Mg²⁺) of at least 1.3. The lithium-free glass composition has a fiberizing temperature no greater than 1,300° C.

### CROSS REFERENCE TO RELATED APPLICATION(S)

This application claims priority to and the benefit of U.S. Provisional Patent Application No. 63/478,712, filed Jan. 6, 2023, the entire content of which is incorporated by reference herein.

### BACKGROUND OF THE INVENTION

Glass fibers are manufactured from various raw materials combined in specific proportions to yield a desired composition, commonly termed a “glass batch.” This glass batch may be melted in a melting apparatus and the molten glass is drawn into filaments through a bushing or orifice plate (the resultant filaments are also referred to as continuous glass fibers). A sizing composition containing lubricants, coupling agents and film-forming binder resins may then be applied to the filaments. After the sizing is applied, the fibers may be gathered into one or more strands and wound into a package or, alternatively, the fibers may be chopped while wet and collected. The collected chopped strands may then be dried and cured to form dry chopped fibers, or they can be packaged in their wet condition as wet chopped fibers.

The composition of the glass batch, along with the fiberglass manufactured therefrom, is often expressed in terms of the oxides contained therein. Numerous types of glasses may be produced by varying the presence or absence of particular oxides or varying particular oxide relationships and ratios within a glass batch. Examples of such glasses that may be produced include R-glass, E-glass, S-glass, A-glass, C-glass, ECR-glass, and more recently, high performance glass (i.e., high modulus and/or high strength glass). The glass composition controls the forming and product properties of the glass. Other characteristics of glass compositions include the raw material cost and availability and environmental impact.

For instance, high performance glass fibers possess higher strength and stiffness, compared to traditional E-glass fibers. In particular, for some products, stiffness is crucial for modeling and performance. For example, composites, such as wind blades, prepared from glass fibers with good stiffness properties would allow for longer wind blades on electrical generating wind stations while keeping flexure of the blade within acceptable limits. Conventionally, lithium is added to glass fiber compositions to obtain both desirable mechanical and forming properties. For example, lithium is very effective in reducing the viscosity of the glass formulation.

Although lithium-containing glass compositions may possess desirable properties with respect to mechanical and forming properties, there are various considerations that make it desirable to reduce and/or eliminate lithium in a glass composition, such as cost, ability to source lithium-containing raw materials, etc.

Glass compositions that target high physical performance often sacrifice glass forming and melt properties, such as AT (temperature differential between a glass composition's liquidus temperature and its fiberizing temperature), to achieve desired end properties. The consequence of this sacrifice is a requirement that the glass be melted in a platinum or platinum-alloy lined furnace, either because the melt temperature exceeds the maximum temperature of the materials forming a conventional refractory furnace or because the viscosity of the glass is such that the temperature of the glass cannot be maintained above the liquidus temperature while producing a sufficient glass viscosity (i.e., the glass has a very small (or negative) AT). The addition of lithium to a glass formulation generally works to expand the AT of glass to permit it to be melted in a standard refractory melter. However, as mentioned above, lithium raw materials are expensive and generally difficult to source in sufficient amounts.

Accordingly, glass compositions that reduce or eliminate lithium are desired that are nonetheless capable of producing high performance (i.e., high Young's modulus) glass fibers, while maintaining desirable forming properties (e.g., liquidus temperature, fiberizing temperature, and the temperature differential therebetween (“AT”).

### SUMMARY OF THE INVENTION

Various exemplary embodiments of the present inventive concepts are directed to a glass composition comprising a high performance, lithium-free glass composition. In any of the exemplary embodiments disclosed herein, the glass composition may comprise: SiO₂ in an amount from 50 to 58% by weight; Al₂O₃ in an amount from 18 to 22% by weight; CaO in an amount from 7 to 12% by weight; MgO in an amount from 11.5 to 15% by weight; Na₂O in an amount from 0.05 to 0.5% by weight; ZrO₂ in an amount from 0 to 5% by weight; and Li₂O in an amount less than 0.5% by weight. The combined amount of SiO₂+Al₂O₃+MgO+CaO is less than or equal to 99.5% by weight. The amounts being expressed as percentages by weight based on the weight of the entire composition. The composition further satisfies at least one of the following: a ratio C1 (C1=SiO₂/(MgO+CaO)) of 2.3-2.7; a ratio C2 (C2=MgO/CaO) of at least 1.3, and a ratio C4 (C4=Al³⁺/Mg²⁺) between 0.5 and 0.61. In any of the exemplary embodiments, the glass composition may satisfy two or more of ratios C1, C2, and C4.

In any of the exemplary embodiments, the glass composition may include MgO in an amount that is greater than 12% by weight and less than 15% by weight, CaO in an amount that is less than 10% by weight, and/or a combined amount of MgO and CaO between 20% by weight and less than 25% by weight.

In any of the exemplary embodiments, the glass composition may further satisfy the ratio C3 (C3=Al₂O₃/MgO) of at least 1.3.

In any of the exemplary embodiments, the glass composition may comprise 0.1 to 3% by weight ZrO₂.

Further aspects of the present inventive concepts are directed to a lithium-free glass composition comprising: SiO₂ in an amount from 50 to 57% by weight; Al₂O₃ in an amount from 18 to 22% by weight; CaO in an amount less than 10% by weight; and MgO in an amount from greater than 12% by weight to less than 15% by weight. The glass composition may further include 0.05% by weight to 5% by weight ZrO₂. The glass composition includes a total concentration of CaO+MgO that is between 20% by weight and less than 25% by weight, expressed as percentages by weight based on the weight of the entire composition. The glass composition may satisfy at least one of the following: a ratio C1 (C1=SiO₂/(MgO+CaO)) of 2.3-2.7; and a ratio C2 (C2=MgO/CaO) of at least 1.3. The glass composition has a fiberizing temperature no greater than 1,300° C. and a liquidus temperature that is less than the fiberizing temperature. In any of the exemplary embodiments, the composition may have a temperature differential (“ΔT”) between the fiberizing temperature and the liquidus temperature that is >0° C. and less than 70° C.

The lithium-free glass composition may further comprise a total content of R₂O (R₂O=Na₂O, Li₂O, and K₂O) is less than 0.5% by weight.

In any of the exemplary embodiments, the lithium-free glass composition may further satisfy at least one of the ratio C3 (C3=Al₂O₃/MgO) of at least 1.3, and the ratio C4 (C4=Al³⁺/Mg²⁺) between 0.5 and 0.61.

The lithium-free glass composition according to any one of claims 9 to 12, wherein the combined amount of SiO₂+Al₂O₃+MgO+CaO is less than or equal to 99.5 wt. %.

Yet further aspects of the present inventive concepts are directed to a glass fiber formed from a glass composition comprising: SiO₂ in an amount from 50 to 57% by weight; Al₂O₃ in an amount from 18 to 22% by weight; CaO in an amount from 7 to 12% by weight; MgO in an amount from 11.5 to 15% by weight; Na₂O in an amount from 0.05 to 0.5% by weight; ZrO₂ in an amount from 0.05% by weight to 5% by weight; and Li₂O in an amount less than 0.5% by weight, expressed as percentages by weight based on the weight of the entire composition. In any of the exemplary embodiments, the glass composition satisfies at least one of the following: a ratio C1 (C1=SiO₂/(MgO+CaO)) of 2.3-2.7; and a ratio C2 (C2=MgO/CaO) of at least 1.3. Additionally, the glass composition has a fiberizing temperature no greater than 1,300° C. and a Young's modulus of at least 90 GPa.

Yet further aspects of the present inventive concepts are directed to methods of forming a continuous glass fiber comprising providing a molten glass composition as described herein; and drawing the molten composition through an orifice to form a continuous glass fiber.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a,” “an,” and “the” are intended to include the plural forms as well, unless the context clearly indicates otherwise.

Unless otherwise indicated, all numbers expressing quantities of ingredients, chemical and molecular properties, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least, each numerical parameter should be construed in light of the number of significant digits and ordinary rounding approaches.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein. Moreover, any numerical value reported in the Examples may be used to define either an upper or lower end-point of a broader compositional range disclosed herein.

The present disclosure relates to a high-modulus glass composition with surprisingly good forming properties, while being essentially lithium free. By “essentially lithium free,” it is meant that the glass composition includes no greater than 2.0% by weight of lithium, including no greater than 1.5% by weight, 1.2% by weight, 1.0% by weight, 0.8% by weight, 0.5% by weight, 0.1% by weight, 0.05% by weight, and 0.01% by weight. In some exemplary embodiments, the glass composition includes between 0 and 1.0% by weight lithium, including between 0 and 0.5% by weight, and between 0 and 0.05% by weight. In some exemplary embodiments, the glass composition is entirely free of lithium.

Removing lithium (in the form of Li₂O) from a glass composition necessarily requires increasing other oxides, particularly when attempting to maintain a high Young's modulus. However, it was surprisingly discovered that the concentration of particular oxides needed to be increased to levels higher than the level of Li₂O that was removed from the composition. In particular, the glass composition according to the present inventive concepts includes a high concentration of magnesium oxide (MgO), while surprisingly demonstrating satisfactory forming properties, including liquidus temperature and the temperature differential (“ΔT”) between the liquidus temperature and the fiberizing temperature, although MgO has traditionally been known to cause higher liquidus temperatures.

Particularly, the present glass composition includes a particular blend of oxides in precise relationships in order to produce a lithium-free glass fiber having a high Young's modulus, while maintaining desirable forming properties. The composition includes, as its basic components, particular amounts of SiO₂, Al₂O₃, CaO, and MgO, with the total amount of SiO₂+Al₂O₃+MgO+CaO being less than or equal to 99.5% by weight. The concentrations of SiO₂, Al₂O₃, CaO, and MgO are such that the glass composition meets one or more of the following relationships: a ratio C1 (C1=SiO₂/(MgO+CaO)) between 2.3 and 2.7; a ratio C2 (C2=MgO/CaO) of at least 1.3; and a ratio C3 (C3=Al₂O₃/MgO) of less than 5. In some exemplary embodiments, the concentrations of SiO₂, Al₂O₃, CaO, and MgO are such that the glass composition meets at least two of the relationships, C1, C2, and C3.

The glass composition may include 50 to 58% by weight SiO₂, 17 to 25% by weight Al₂O₃, 11 to 15% by weight MgO, 7 to 12% by weight CaO, 0 to 1% by weight Na₂O, 0 to 1% by weight TiO₂, 0 to 1% by weight Fe₂O₃, and no more than 0.3% by weight Li₂O.

Advantageously, the glass composition meets at least two or more of the following relationships: C1 (C1=SiO₂/(MgO+CaO)) of 2.3-2.7; a ratio C2 (C2=MgO/CaO) of at least 1.3; and a ratio C3 (C3=Al₂O₃/MgO) of at least 1.3.

The glass composition includes at least 50% by weight, but no greater than 60% by weight SiO₂. The glass composition may include at least 52% by weight SiO₂, including at least 53.5% by weight, at least 54% by weight, at least 55% by weight, and at least 55.5% by weight. In some instances, the glass composition includes no greater than 59.5% by weight SiO₂, including no greater than 59% by weight, no greater than 58.5% by weight, no greater than 58% by weight, no greater than 57.8% by weight, no greater than 57.5% by weight, no greater than 57.2% by weight, no greater than 57% by weight, no greater than 56.8% by weight, and no greater than 56.55% by weight.

Thus, certain embodiments of the glass composition include SiO₂ in an amount between 50% by weight and less than 60% by weight, including, for example, between 53% by weight and 59% by weight, 53.5% by weight and 58% by weight, 54% by weight and 57.5% by weight, and 54.5% by weight and 57% by weight, including all subranges and endpoints therein.

To achieve both the desired mechanical and fiberizing properties, the glass composition has an Al₂O₃ concentration of at least 17% by weight and no greater than 25% by weight. Al₂O₃ helps to improve glass modulus, but also tends to increase the glass liquidus, which could impact the glass AT. Thus, the subject glass composition includes a balanced amount of Al₂O₃ in comparison to other oxides to achieve the highest benefit to modulus with as little impact to the liquidus temperature as possible. In some embodiments, the glass composition includes Al₂O₃ in an amount between 17.5% by weight and 24% by weight, including between 18% by weight and 23% by weight, between 18.5% by weight and 22% by weight, between 19% by weight and 21.5% by weight, and between 19.5% by weight and 21% by weight, including all endpoints and subranges therebetween.

As mentioned above, it has been surprisingly discovered that glass composition can include a relatively high concentration of MgO, while maintaining sufficient melt and forming properties. Thus, the glass composition includes at least 11% by weight MgO, including at least 11.25% by weight, at least 11.5% by weight, at least 12% by weight, at least 12.25% by weight, and at least 12.5% by weight MgO. Additionally, the glass composition includes less than 16% by weight MgO, including no greater than 15.5% by weight, no greater than 15% by weight, no greater than 14.8% by weight, and no greater than 14.5% by weight MgO. Including greater than 16% by weight MgO will cause the liquidus temperature to increase to an unacceptable level, which also increases the glass's crystallization tendency. In some exemplary embodiments, the glass composition includes 11% by weight to 15% by weight MgO, including 11.5% by weight to less than 15% by weight, 12% by weight to 14.8% by weight, and greater than 12% by weight to 14.6% by weight, including all endpoints and subranges therebetween.

Another important aspect of the subject glass composition that makes it possible to achieve the desired mechanical and fiberizing properties, is having an Al₂O₃/MgO ratio of at least 1.3. It has been discovered that glass fibers having compositions with otherwise similar compositional ranges, but with Al₂O₃/MgO ratios less than 1.3 are unable to achieve a Young's modulus of at least 88 GPa, while also maintaining sufficient fiberizing properties. In certain exemplary aspects, the Al₂O₃/MgO ratio is greater than or equal to 1.4, or greater than or equal to 1.45, or greater than or equal to 1.5. The Al₂O₃ ratio should also be no greater than 2, such as no greater than 1.9, and no greater than 1.85, makes it possible to obtain glass fibers with desirable fiberizing properties and Young's modulus of at least 88 GPa.

As oxide cations generally impact the properties of a glass composition, one way to characterize the glass composition is through the molar concentration of particular cations, such as Al³⁺ and Mg²⁺. Aluminum is either four-, five-, or six coordinated, with a higher coordination leading to higher glass stiffness. The alkaline earth cation, MgO, with its +2 charge and small ionic radius is uniquely suited to provide charge compensation to yield AlO₅ (Al⁵⁺). However, each alkaline earth cation creates two non-bridging oxygen, which work to depolymerize the glass structure. Accordingly, the present glass composition achieves a balance between Al³⁺ and Mg²⁺ cations, to achieve an optimal connectivity, without depolymerization of the glass structure. Such a balance presents itself in such a way that the Al³⁺/Mg²⁺ ratio is between 0.5 and 0.61, and in some instances between 0.505 and 0.57, or between 0.51 and 0.56, including all endpoints and subranges therebetween.

The glass composition advantageously includes at least 7% by weight and no greater than 12% by weight CaO. CaO tends to negatively impact Young's modulus, and therefore including greater than 12% by weight CaO may produce a glass with a low Young's modulus. Including less than 7% by weight will either unfavorably increase the liquidus temperature or the glass viscosity depending on what the CaO is substituted with. In some exemplary embodiments, the glass composition includes at least 8% by weight CaO, including at least 8.3% by weight, at least 8.5% by weight, at least 8.7% by weight, and at least 9% by weight. The glass composition further includes no greater than 13% by weight CaO, such as, for example, no greater than 12.5% by weight, no greater than 12% by weight, no greater than 11.8% by weight, no greater than 11.5% by weight, no greater than 11.2% by weight, no greater than 11% by weight, no greater than 10.8% by weight, no greater than 10.4% by weight, and no greater than 10% by weight. In some exemplary embodiments, the glass composition includes less than 10% by weight CaO.

The glass composition includes a total concentration of MgO and CaO that is at least 20% by weight and no greater than 26% by weight, including between 20.5% by weight and 25.5% by weight and between 21% by weight and 25% by weight. In any of the exemplary embodiments, the total concentration of MgO and CaO may be at least 20% by weight.

The glass composition further includes a combined amounts of SiO₂, Al₂O₃, MgO, and CaO that is less than or equal to 99.5% by weight and at least 98% by weight, or at least 99% by weight. In some exemplary embodiments, the combined amounts of SiO₂, Al₂O₃, MgO, and CaO is between 98.3% by weight and 99.5% by weight, including between 98.5% by weight and 99.4% by weight and 98.7% by weight and 99.3% by weight.

The glass composition may include up to about 2% by weight TiO₂. In some exemplary embodiments, the glass composition includes about 0.01% by weight to about 1% by weight TiO₂, including about 0.1% by weight to about 0.8% by weight and about 0.2 to about 0.7% by weight.

The glass composition may include up to about 5% by weight ZrO₂. In some exemplary embodiments, the glass composition includes about 0.01% by weight to about 3% by weight ZrO₂, including about 0.05% by weight to about 2.5% by weight, about 0.1% by weight to about 2% by weight, about 0.25% by weight and about 1.75% by weight, about 0.5% by weight and about 1.5% by weight, about 0.7% by weight and about 1.25% by weight, including all endpoints and subranges therebetween.

The glass composition may include up to about 2% by weight Fe₂O₃. In some exemplary embodiments, the glass composition includes about 0.01% by weight to about 1.0% by weight Fe₂O₃, including about 0.05% by weight to about 0.6% by weight and about 0.1 to about 0.5% by weight.

The glass composition includes less than 2% by weight of the alkali metal oxides Na₂O and K₂O, including between 0 and 1.5% by weight, and between an amount greater than 0 and 1% by weight. The glass composition may advantageously include both Na₂O and K₂O in an amount greater than 0.01% by weight of each oxide. In some exemplary embodiments, the glass composition includes 0 to about 1% by weight Na₂O, including about 0.01 to about 0.5% by weight, about 0.03 to about 0.3% by weight, and 0.04 to about 0.2% by weight. In these or other embodiments, the glass composition may further include about 0 to about 1% by weight K₂O, including about 0.01 to about 0.5% by weight, about 0.03 to about 0.3% by weight, and 0.04 to about 0.2% by weight.

It is an object of the present inventive concepts to formulate a high performance (and particularly, a high modulus) glass composition that is free or substantially free of Li₂O. Accordingly, the glass composition includes no greater than 2% by weight of Li₂O, including no greater than 1.5% by weight, 1.2% by weight, 1% by weight, 0.8% by weight, 0.5% by weight, 0.1% by weight, 0.05% by weight, and 0.01% by weight. In some exemplary embodiments, the glass composition includes between 0 and less than 1% by weight Li₂O, including between 0 and 0.5% by weight, between 0 and 0.5% by weight, and between 0 and 0.05% by weight. In some exemplary embodiments, the glass composition is entirely free of Li₂O.

The glass composition may also be free or substantially free of B₂O₃ and fluorine, although either, or any, may be added in small amounts to adjust the fiberizing and finished glass properties and will not adversely impact the properties if maintained below several percent. As used herein, substantially free of B₂O₃ and fluorine means that the sum of the amounts of B₂O₃ and fluorine present is less than 1.0% by weight of the composition. The sum of the amounts of B₂O₃ and fluorine present may be less than about 0.5% by weight of the composition, including less than about 0.2% by weight, less than about 0.1% by weight, and less than about 0.05% by weight.

As used herein, the terms “weight percent,” “% by weight,” “wt. %,” and “percent by weight” may be used interchangeably and are meant to denote the weight percent (or percent by weight) based on the total composition.

The glass compositions may further include impurities and/or trace materials without adversely affecting the glasses or the fibers. These impurities may enter the glass as raw material impurities or may be products formed by the chemical reaction of the molten glass with furnace components. Non-limiting examples of trace materials include zinc, strontium, barium, and combinations thereof. The trace materials may be present in their oxide forms and may further include fluorine and/or chlorine. In some exemplary embodiments, the inventive glass compositions contain less than 1% by weight, including less than 0.5% by weight, less than 0.2% by weight, and less than 0.1% by weight of each of BaO, SrO, ZnO, P₂O₅, and SO₃. Particularly, the glass composition may include less than about 5.0% by weight of BaO, SrO, ZnO, ZrO₂, P₂O₅, and/or SO₃ combined, wherein each of BaO, SrO, ZnO, P₂O₅, and SO₃ if present at all, is present in an amount of less than 1% by weight.

The glass composition may be in molten form, obtainable by melting the raw material components of the glass composition in a melter. The glass compositions disclosed herein are suitable for melting in traditional commercially available refractory-lined glass furnaces, which are widely used in the manufacture of glass reinforcement fibers.

Surprisingly, the glass composition demonstrates an acceptably low liquidus temperature, while including a relatively high concentration of MgO (a minimum of 11% by weight). The liquidus temperature is defined as the highest temperature at which equilibrium exists between liquid glass and its primary crystalline phase. The liquidus temperature, in some instances, may be measured by exposing the glass composition to a temperature gradient in a platinum-alloy boat for 16 hours (ASTM C829-81 (2005)). At all temperatures above the liquidus temperature, the glass is completely molten, i.e., it is free from crystals. At temperatures below the liquidus temperature, crystals may form.

The glass composition has a liquidus temperature below 1,350° C., including liquidus temperature of no greater than 1,325° C., no greater than 1,300° C., no greater than 1,285° C., no greater than 1,265° C., no greater than 1,250° C., no greater than 1,245° C., and no greater than 1,240° C. In any of the embodiments disclosed herein, the glass composition may have a liquidus temperature of less than 1,300° C., or less than 1,280° C., less than 1,260° C., less than 1,250° C., or less than 1,245° C.

The glass composition also exhibits a low fiberizing temperature, which is defined as the temperature that corresponds to a melt viscosity of about 1000 Poise, as determined by ASTM C965-96 (2007) (also known as the log 3 temperature). Lowering the fiberizing temperature may reduce the production cost of the glass fibers because it allows for a longer bushing life and reduced energy usage necessary for melting the components of a glass composition. Therefore, the energy expelled is generally less than the energy necessary to melt many commercially available glass formulations. Such lower energy requirements may also lower the overall manufacturing costs associated with the glass composition.

For example, at a lower fiberizing temperature, a bushing may operate at a cooler temperature and therefore does not “sag” as quickly as is typically seen. “Sag” is a phenomenon that occurs when a bushing that is held at an elevated temperature for extended periods of time loses its determined stability. Thus, by lowering the fiberizing temperature, the sag rate of the bushing may be reduced, and the bushing life can be maximized.

The glass composition has a fiberizing temperature of less 1,350° C., such as, for example, a fiberizing temperature of no greater than 1,325° C., no greater than 1,300° C., no greater than 1,290° C., no greater than 1,285° F., and no greater than 1,275° F. In any of the embodiments disclosed herein, the glass composition may have a liquidus temperature of less than 1,300° C., or less than 1,290° C., less than 1,288° C., less than 1,280° C., or less than 1,275° C.

The glass composition further includes a positive (>0° C.) temperature differential “AT”, which is defined as the difference between the fiberizing temperature and the liquidus temperature. To make a glass fiber, batch ingredients are first eutectically melted and dissolved at a very high temperature in the furnace. This melting temperature is far above both the liquidus temperature and fiberizing temperature. Once melted, the molten glass travels through what is known as a “front end” or forehearth and cools as it travels. Ideally, the molten glass is delivered to a bushing right at the fiberizing temperature and never drops below this temperature. Thus, it is important that the AT is positive to prevent devitrification or crystals from forming.

In some exemplary embodiments, the glass composition has a AT of at least 1° C., including at least 5° C., at least 10° C., at least 12° C., at least 15° C., at least 17° C., at least 20° C., at least 25° C., at least 30° C., at least 35° C., at least 40° C., and at least 45° C. In various exemplary embodiments, the glass composition has a AT between 5° C. and 50° C., including between 10° C. and 35° C., and between 15° C. and 30° C., including any endpoints and subranges therebetween.

As mentioned above, the glass composition comprises a lithium-free unique blend of oxides that is capable of forming a glass fiber with a high Young's modulus and sufficient forming properties. Particularly, the lithium-free glass composition includes a positive AT and is capable of forming a glass fiber with a Young's modulus of at least 88 GPa.

The Young's modulus (or “elastic modulus”) of a glass fiber may be determined by taking the average measurements on five single glass fibers measured in accordance with the sonic measurement procedure outlined in the report “Glass Fiber and Measuring Facilities at the U.S. Naval Ordnance Laboratory”, Report Number NOLTR 65-87, Jun. 23, 1965. In comparison, another method of measuring modulus is to measure the bulk modulus. Modulus measurements on bulk samples are not representative of the fiber product modulus because of the different thermal histories involved in forming the types of samples. Furthermore, bulk samples must be annealed prior to the cutting, grinding, and polishing required to produce the specific samples needed for the bulk measurement. This annealing step takes the bulk sample atomic structure even further from that of the fiber. Thus, such bulk modulus measurements are not directly comparable to fiber modulus, described herein. Bulk modulus measurements are described in ASTM C1259 or E1876.

The glass fibers formed from the inventive glass composition have a Young's modulus (fiber modulus) of at least about 88 GPa, such as a Young's modulus of at least about 88.5 GPa, at least about 89 GPa, at least about 89.5 GPa, at least about 90 GPa, at least about 90.5 GPa, at least about 91 GPa. In some exemplary embodiments, the exemplary glass fibers formed from the inventive glass composition have a Young's modulus of between about 85 GPa and about 95 GPa, including between about 87 GPa and about 92 GPa, and between about 88 GPa and about 91 GPa.

The glass fibers formed from the composition disclosed herein further have a sufficient tensile strength, which is also referred to herein simply as “strength.” In some exemplary embodiments, the tensile strength is measured on pristine fibers (i.e., unsized and untouched laboratory produced fibers) using an Instron tensile testing apparatus according to ASTM D2343-09. Exemplary glass fibers formed form the above-described inventive glass composition may have a fiber tensile strength of at least 4,000 MPa, including at least 4,200 MPa, at least 4300 MPa, at least 4,400 MPa, at least 4,500 MPa, and at least 4,600 MPa.

Table 1, below, provides exemplary glass compositional ranges, in accordance with the present inventive concepts.

TABLE 1

| | Compositional | Compositional |
|---|---|---|
| Oxides | Range A | Range B |
| SiO₂ | 50-58 | 50-57 |
| Al₂O₃ | 18-22 | 18-21 |
| MgO | 11.5-15 | >12 and <15 |
| CaO | 7-12 | less than 11 |
| ZrO₂ | 0-5 | 0.25-2 |
| Fe₂O₃ | 0-0.5 | |
| K₂O | 0.05-0.5 | |
| Na₂O | 0.05-0.5 | |
| Li₂O | 0-0.5 | 0-0.1 |
| TiO₂ | 0-1.0 | |
| Two or more of: | | |
| SiO₂ + Al₂O₃ + MgO + CaO | ≤99.5 | ≤99.5 |
| MgO + CaO | 20 to less than 25 | 21 to 24 |
| SiO₂/(MgO + CaO) | 2.3-2.7 | 2.4-2.6 |
| MgO/CaO | at least 1.3 | at least 1.4 |
| MgO + Al₂O₃ | >30 | >32 |
| Al₂O₃/MgO | at least 1.3 | at least 1.4 |
| Al³⁺/Mg²⁺ | 0.5-0.61 | 0.505 and 0.57 |
| SiO₂/MgO | less than 5 | less than 5 |

According to some exemplary embodiments, a method is provided for preparing glass fibers from the glass composition described above. The glass fibers may be formed by any means known and traditionally used in the art. In some exemplary embodiments, the glass fibers are formed by obtaining raw ingredients and mixing the ingredients in the appropriate quantities to give the desired weight percentages of the final composition. The method may further include providing the inventive glass composition in molten form and drawing the molten composition through orifices in a bushing to form a glass fiber.

The components of the glass composition may be obtained from suitable ingredients or raw materials including, but not limited to, sand or pyrophyllite for SiO₂, limestone, burnt lime, wollastonite, or dolomite for CaO, kaolin, alumina or pyrophyllite for Al₂O₃, dolomite, dolomitic quicklime, brucite, enstatite, talc, burnt magnesite, or magnesite for MgO, and sodium carbonate, sodium feldspar or sodium sulfate for the Na₂O. In some exemplary embodiments, glass cullet may be used to supply one or more of the needed oxides.

The mixed batch may then be melted in a furnace or melter and the resulting molten glass is passed along a forehearth and drawn through the orifices of a bushing located at the bottom of the forehearth to form individual glass filaments. In some exemplary embodiments, the furnace or melter is a traditional refractory melter. By utilizing a refractory tank formed of refractory blocks, manufacturing costs associated with the production of glass fibers produced by the inventive composition may be reduced. In some exemplary embodiments, the bushing is a platinum alloy-based bushing. Strands of glass fibers may then be formed by gathering the individual filaments together. The fiber strands may be wound and further processed in a conventional manner suitable for the intended application.

The operating temperatures of the glass in the melter, forehearth, and bushing may be selected to appropriately adjust the viscosity of the glass, and may be maintained using suitable methods, such as control devices. The temperature at the front end of the melter may be automatically controlled to reduce or eliminate devitrification. The molten glass may then be pulled (drawn) through holes or orifices in the bottom or tip plate of the bushing to form glass fibers. In accordance with some exemplary embodiments, the streams of molten glass flowing through the bushing orifices are attenuated to filaments by winding a strand formed of a plurality of individual filaments on a forming tube mounted on a rotatable collet of a winding machine or chopped at an adaptive speed. The glass fibers of the invention are obtainable by any of the methods described herein, or any known method for forming glass fibers.

The fibers may be further processed in a conventional manner suitable for the intended application. For instance, in some exemplary embodiments, the glass fibers are sized with a sizing composition known to those of skill in the art. The sizing composition is in no way restricted and may be any sizing composition suitable for application to glass fibers. The sized fibers may be used for reinforcing substrates such as a variety of plastics where the product's end use requires high strength and stiffness and low weight. Such applications include, but are not limited to, woven fabrics for use in forming wind blades; infrastructure, such as reinforcing concrete, bridges, etc.; and aerospace structures.

In this regard, some exemplary embodiments of the present invention include a composite material incorporating the inventive glass fibers, as described above, in combination with a hardenable matrix material. This may also be referred to herein as a reinforced composite product. The matrix material may be any suitable thermoplastic or thermoset resin known to those of skill in the art, such as, but not limited to, thermoplastics such as polyesters, polypropylene, polyamide, polyethylene terephthalate, and polybutylene, and thermoset resins such as epoxy resins, unsaturated polyesters, phenolics, vinyl esters, and elastomers. These resins may be used alone or in combination. The reinforced composite product may be used for wind blade, rebar, pipe, filament winding, muffler filling, sound absorption, and the like.

In accordance with further exemplary embodiments, the invention provides a method of preparing a composite product as described above. The method may include combining at least one polymer matrix material with a plurality of glass fibers. Both the polymer matrix material and the glass fibers may be as described above.

### EXAMPLES

Exemplary glass compositions according to the present invention were prepared by mixing batch components in proportioned amounts to achieve a final glass composition with the oxide weight percentages set forth in Table 2, below.

The raw materials were melted in a platinum crucible in an electrically heated furnace at a temperature of 1,650° C. for 3 hours.

The fiberizing temperature was measured using a rotating cylinder method as described in ASTM C965-96 (2007), entitled “Standard Practice for Measuring Viscosity of Glass Above the Softening Point,” the contents of which are incorporated by reference herein. The liquidus temperature was measured by exposing glass to a temperature gradient in a platinum-alloy boat for 16 hours, as defined in ASTM C829-81 (2005), entitled “Standard Practices for Measurement of Liquidus Temperature of Glass,” the contents of which are incorporated by reference herein. Density was measured by the Archimedes method, as detailed in ASTM C693-93 (2008), entitled “Standard Test Method for Density of Glass Buoyancy,” the contents of which are incorporated by reference herein.

The strength was measured on pristine fibers using an Instron tensile testing apparatus according to ASTM D2343-09 entitled, “Standard Test Method for Tensile Properties of Glass Fiber Strands, Yarns, and Rovings Used in Reinforced Plastics,” the contents of which are incorporated by reference herein.

TABLE 2
(in % by weight)

| | | | | Comp. | Comp. | Comp. | Comp. |
|---|---|---|---|---|---|---|---|
| | Ex. 1 | Ex. 2 | Ex. 3 | Ex. 1 | Ex. 2 | Ex. 3 | Ex. 4 |
| Component | | | | | | | |
| SiO₂ | 56.80 | 55.90 | 56.80 | 55.10 | 58.02 | 58.1 | 58.00 |
| Al₂O₃ | 20.20 | 20.20 | 20.40 | 18.00 | 21.01 | 20.1 | 20.00 |
| MgO | 13.00 | 14.00 | 12.80 | 14.10 | 10.05 | 12.1 | 11.15 |
| CaO | 9.00 | 9.00 | 9.50 | 12.80 | 8.69 | 9.5 | 9.00 |
| Fe₂O₃ | 0.30 | 0.20 | 0.10 | / | 0.32 | 0.1 | 0.30 |
| K₂O | 0.10 | 0.10 | 0.10 | / | / | / | 0.07 |
| Na₂O | 0.10 | 0.10 | 0.10 | / | 1.07 | 0.1 | 0.14 |
| Li₂O | 0.00 | 0.00 | 0.00 | / | / | / | 0.00 |
| TiO₂ | 0.50 | 0.50 | 0.20 | / | 0.83 | / | 0.63 |
| SrO | 0.02 | 0.02 | 0.02 | / | / | / | / |
| MgO + CaO | 22.00 | 23.00 | 22.30 | 26.90 | 18.74 | 21.6 | 20.15 |
| SiO₂/ | 2.58 | 2.43 | 2.55 | 2.04 | 3.10 | 2.69 | 2.90 |
| (MgO + CaO) | | | | | | | |
| MgO/ | 1.44 | 1.56 | 1.35 | 1.10 | 1.16 | 1.27 | 1.24 |
| CaO | | | | | | | |
| SiO₂ᵥ + | 99 | 99.10 | 99.50 | 100.00 | 97.77 | 99.8 | 98.15 |
| Al₂O₃ + | | | | | | | |
| MgO + CaO | | | | | | | |
| MgO + | 33.20 | 34.20 | 33.20 | 32.10 | 31.06 | 32.2 | 31.15 |
| Al₂O₃ | | | | | | | |
| Al₂O₃/ | 1.55 | 1.44 | 1.59 | 1.27 | 2.09 | 1.66 | 1.79 |
| MgO | | | | | | | |
| SiO₂/ | 4.30 | 3.99 | 4.44 | 3.9 | 5.77 | 4.8 | 5.26 |
| MgO | | | | | | | |
| Property | | | | | | | |
| Modulus | 91.06 | 91.56 | 90.70 | 97.5 | 95.10 | 98 | |
| (GPa) | | | | (bulk) | | | |
| Viscosity | 1,276 | 1,261 | 1,280 | 1,227 | 1,326 | 1,302 | 1,310 |
| (° C.) | | | | (predicted) | | | |
| Liquidus | 1,236 | 1,241 | 1,234 | 1,261 | 1,250 | 1,223 | 1,212.22 |
| (° C.) | | | | (predicted) | | | |
| Delta T (° C.) | 40 | 20 | 46 | −34 | 76 | 79 | 80 |
| Density | 2.65 | 2.65 | 2.64 | 2.68 | 2.60 | | 2.61 |
| (g/cc) | | | | (predicted) | | | |
| Strength | | | 4,520 | | | | 4918 |
| (MPa) | | | | | | | |

Examples 1 to 3 above in Table 2 comprise exemplary glass formulations in accordance with the present inventive concepts. Comparative Examples 1 to 4 are replicated comparative examples from various prior art documents. Comparative Example 1 is Example 5 from U.S. Pat. No. 9,102,564, owned by 3B Fiberglass. Comparative Example 2 is Example 12 from U.S. Pat. No. 9,783,454, owned by AGY. Comparative Example 3 is Example 5 from U.S. Pat. No. 8,841,222, owned by Nitto Boseki. Comparative Example 4 is Example 12 from U.S. Pat. No. 11,214,512, owned by Owens Corning.

Each of Examples 1 to 3 comprise glass compositions that fall within the following parameters: 50% to 57% by weight SiO₂, 18% to 22% by weight Al₂O₃, 11% to 15% by weight MgO, 7 to 12% by weight CaO, 0 to 0.5% by weight Na₂O, 0 to 1% by weight TiO₂, 0 to 0.5% by weight Fe₂O₃, and less than 0.5% by weight Li₂O, with a total MgO+CaO concentration of 20 to less than 25% by weight, an MgO/CaO ratio of at least 1.3, an Al₂O₃/MgO ratio of at least 1.3, and a total concentration of SiO₂+Al₂O₃+MgO+CaO of less than or equal to 99.5% by weight, which results in compositions having low fiberizing temperatures (as determined by ASTM C965-96 (2007)) of less than 1,300° C. that are capable of forming glass fibers with a Young's modulus of greater than 90 GPa.

In contrast, Comparative Examples 1 to 4 include glass compositions that fall outside one or more of the compositional ranges and one or more of the compositional relationships mentioned above and each includes a fiberizing temperature of greater than 1,300 C° and delta T values of greater than 70° C.

TABLE 3
(in % by weight)

| | Ex. 4 | Ex. 5 | Ex. 6 | Ex. 7 | Ex. 8 | Ex. 9 | Ex. 10 |
|---|---|---|---|---|---|---|---|
| Component | | | | | | | |
| SiO₂ | 55.74 | 57.6 | 56.7 | 56.55 | 56.4 | 56.23 | 56.00 |
| Al₂O₃ | 20.09 | 20.5 | 20.4 | 20.5 | 20.5 | 20.44 | 20.36 |
| MgO | 12.80 | 12.2 | 12.6 | 12.5 | 12.5 | 12.46 | 12.41 |
| CaO | 8.86 | 8.7 | 9.3 | 9.3 | 9.3 | 9.27 | 9.23 |
| Fe₂O₃ | 0.3 | 0.1 | 0.1 | 0.08 | 0.08 | 0.08 | 0.08 |
| K₂O | 0.1 | 0.1 | 0.1 | 0.02 | 0.02 | 0.02 | 0.02 |
| Na₂O | 0.1 | 0.1 | 0.1 | 0.1 | 0.1 | 0.10 | 0.10 |
| Li₂O | 0 | 0 | 0 | 0 | 0 | 0 | 0 |
| TiO₂ | 0.5 | 0.2 | 0.2 | 0.2 | 0.2 | 0.20 | 0.20 |
| ZrO2 | 0.5 | 0.5 | 0.5 | 0.75 | 0.9 | 1.2 | 1.6 |
| MgO + CaO | 21.66 | 20.9 | 21.9 | 21.8 | 21.8 | 21.73 | 21.64 |
| SiO₂/ | 2.57 | 2.51 | 2.59 | 2.59 | 2.59 | 2.59 | 2.59 |
| (MgO + CaO) | | | | | | | |
| MgO/ | 1.44 | 1.4 | 1.35 | 1.34 | 1.34 | 1.34 | 1.34 |
| CaO | | | | | | | |
| SiO₂ᵥ + | 98.3 | 99 | 99 | 98.85 | 98.7 | 98.4 | 98 |
| Al₂O₃ + | | | | | | | |
| MgO + CaO | | | | | | | |
| MgO + | 32.89 | 32.7 | 33 | 33 | 33 | 32.9 | 32.77 |
| Al₂O₃ | | | | | | | |
| Al₂O₃/ | 1.56 | 1.68 | 1.62 | 1.64 | 1.64 | 1.64 | 1.64 |
| MgO | | | | | | | |
| SiO₂/ | 4.35 | 4.72 | 4.5 | 4.52 | 4.51 | 4.51 | 4.51 |
| MgO | | | | | | | |
| Property | | | | | | | |
| Modulus | 91.4 | 90.1 | 90.8 | 90.9 | 91.0 | 91.2 | 91.5 |
| (GPa) | | | | | | | |
| Viscosity | 1,270 | 1,304 | 1,287 | 1,283 | 1,280 | 1,282 | 1,283 |
| (° C.) | | | | | | | |
| Liquidus | 1,241 | 1,238 | 1,239 | 1,236 | 1,241 | 1,240 | 1,240 |
| (° C.) | | | | | | | |
| Delta T (° C.) | 29 | 66 | 49 | 47 | 39 | 41 | 43 |
| Density | 2.67 | 2.62 | 2.64 | 2.65 | 2.65 | 2.65 | 2.66 |
| (g/cc) | | | | | | | |

Examples 4 to 10 above in Table 3 comprise exemplary glass formulations in accordance with the present inventive concepts that include at least 0.5 wt. % ZrO₂. Each of Examples 4 to 10 comprise glass compositions that fall within the following parameters: 50% to 58% by weight SiO₂, 18% to 22% by weight Al₂O₃, 11% to 15% by weight MgO, 7 to 12% by weight CaO, 0 to 0.5% by weight Na₂O, 0 to 1% by weight TiO₂, 0 to 0.5% by weight Fe₂O₃, and less than 0.5% by weight Li₂O, with a total MgO+CaO concentration of 20 to less than 25% by weight, an MgO/CaO ratio of at least 1.3, an Al₂O₃/MgO ratio of at least 1.3, and a total concentration of SiO₂+Al₂O₃+MgO+CaO of less than or equal to 99.5% by weight, which results in compositions having low fiberizing temperatures (as determined by ASTM C965-96 (2007)) of less than 1,300° C. that are capable of forming glass fibers with a Young's modulus of greater than 90 GPa.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A glass composition comprising:
SiO₂ in an amount from 50 to 58% by weight;
Al₂O₃ in an amount from 18 to 22% by weight;
CaO in an amount from 7 to 12% by weight;
MgO in an amount from 11.5 to 15% by weight;
Na₂O in an amount from 0.05 to 0.5% by weight;
ZrO₂ in an amount from 0 to 5 wt. %; and
Li₂O in an amount less than 0.5% by weight, and
the combined amount of SiO₂+Al₂O₃+MgO+CaO is less than or equal to 99.5% by weight;
expressed as percentages by weight based on the weight of the entire composition, wherein the composition satisfies at least one of the following:
a ratio C1 (C1=SiO₂/(MgO+CaO)) of 2.3-2.7;
a ratio C2 (C2=MgO/CaO) of at least 1.3, and
a ratio C4 (C4=Al³⁺/Mg²⁺) between 0.5 and 0.61, and wherein said glass composition has a fiberizing temperature no greater than 1,300° C.

2. The glass composition according to claim 1, wherein MgO is present in an amount that is greater than 12% by weight and less than 15% by weight.

3. The glass composition according to claim 1, wherein CaO is present in an amount that is less than 10% by weight.

4. The glass composition according to claim 1, wherein a combined amounts of MgO and CaO is between 20% by weight and less than 25% by weight.

5. The glass composition according to claim 1, wherein said composition includes less than 0.05% by weight of Li₂O.

6. The glass composition according to claim 1, wherein said composition satisfies the ratio C3 (C3=Al₂O₃/MgO) of at least 1.3.

7. The glass composition according to claim 1, wherein the composition satisfies at least two of ratios C1, C2 and C4.

8. A glass fiber comprising a composition according to claim 1, wherein the combined glass fiber has a Young's modulus of greater than 90 GPa.

9. A lithium-free glass composition comprising:
SiO₂ in an amount from 50 to 57% by weight;
Al₂O₃ in an amount from 18 to 22% by weight;
CaO in an amount less than 10% by weight; and
MgO in an amount from greater than 12% by weight to less than 15% by weight, wherein a total concentration of CaO+MgO is between 20% by weight and less than 25% by weight, expressed as percentages by weight based on the weight of the entire composition, wherein the glass composition satisfies the following:
a ratio C1 (C1=SiO₂/(MgO+CaO)) of 2.3-2.7; and
a ratio C2 (C2=MgO/CaO) of at least 1.3, wherein the glass composition has a fiberizing temperature no greater than 1,300° C.

10. The lithium-free glass composition according to claim 9, wherein the composition comprises a total content of R₂O (R₂O═Na₂O, Li₂O, and K₂O) is less than 0.5% by weight.

11. The lithium-free glass composition according to claim 9, wherein said composition satisfies the ratio C3 (C3=Al₂O₃/MgO) of at least 1.3.

12. The lithium-free glass composition according to claim 9, wherein said composition satisfies the ratio C4 (C4=Al³⁺/Mg²⁺) between 0.5 and 0.61.

13. The lithium-free glass composition according to claim 9, wherein the combined amount of SiO₂+Al₂O₃+MgO+CaO is less than or equal to 99.5 wt. %.

14. The lithium-free glass composition according to claim 9, wherein the composition includes 0.05 to 3 wt. % ZrO₂.

15. The lithium-free glass composition according to claim 9, wherein the composition has a liquidus temperature that is less than the fiberizing temperature.

16. The lithium-free glass composition according to claim 14, wherein said composition has a temperature differential (“ΔT”) between the fiberizing temperature and the liquidus temperature that is >0° C. and less than 70° C.

17. A glass fiber formed from a glass composition comprising:
SiO₂ in an amount from 50 to 57% by weight;
Al₂O₃ in an amount from 18 to 22% by weight;
CaO in an amount from 7 to 12% by weight;
MgO in an amount from 11.5 to 15% by weight;
Na₂O in an amount from 0.05 to 0.5% by weight;
ZrO₂ in an amount from 0 to 5% by weight; and
Li₂O in an amount less than 0.5% by weight, expressed as percentages by weight based on the weight of the entire composition, wherein the glass composition satisfies the following:
a ratio C1 (C1=SiO₂/(MgO+CaO)) of 2.3-2.7; and
a ratio C2 (C2=MgO/CaO) of at least 1.3, wherein the glass composition has a fiberizing temperature no greater than 1,300° C., and wherein the glass fiber has a Young's modulus of at least 90 GPa.

18. The glass fiber according to claim 17, wherein the composition satisfies a ratio C3 (C3=Al₂O₃/MgO) of at least 1.3.

19. A method of forming a continuous glass fiber comprising:
providing a molten glass composition according to claim 1; and
drawing said molten composition through an orifice to form a continuous glass fiber.

20. A reinforced composite product comprising;
a polymer matrix; and
a plurality of glass fibers formed in accordance with claim 17.

21. A reinforced composite product according to claim 20, wherein the reinforced composite product is in the form of a wind blade.
